(19) United States
(12) Patent Application Publication
(10) Pub. No.: US 2022/0253466 A1
(43) Pub. Date: Aug. 11, 2022

(54) METHODS AND APPARATUS TO ESTIMATE A DEDUPLICATED AUDIENCE OF A PARTITIONED AUDIENCE OF MEDIA PRESENTATIONS

(71) Applicant: The Nielsen Company (US), LLC, New York, NY (US)

(72) Inventors: Michael R. Sheppard, Holland, MI (US); DongBo Cui, New York, NY (US); David Forteguerre, Brooklyn, NY (US); Jessica Lynn White, Plant City, FL (US); Edward Murphy, North Stonington, CT (US)

(21) Appl. No.: 17/667,532

(22) Filed: Feb. 8, 2022

Related U.S. Application Data
(60) Provisional application No. 63/146,932, filed on Feb. 8, 2021.

(51) Int. Cl. G06F 16/28; G06F 16/215; G06F 16/2455; G06F 16/901

(52) U.S. Cl. CPC G06F 16/288; G06F 16/9024; G06F 16/2456; G06F 16/215

(57) ABSTRACT

Methods, and apparatus are disclosed to estimate a deduplicated audience of a partitioned audience of media presentations. An example apparatus includes interface circuitry, instructions in the apparatus, and processor circuitry to execute the instructions to at least: identify one or more nodes of a graph structure selected for estimation of a deduplicated audience, and estimate a value indicative of the deduplicated audience across a first selected node of the graph structure and a second selected node of the graph structure.

### RELATED APPLICATIONS

This patent is a non-provisional and claims the benefit of U.S. Provisional Patent Application Ser. No. 63/146,932, filed Feb. 8, 2021, which is hereby incorporated by reference herein in its entirety.

### FIELD OF THE DISCLOSURE

This disclosure relates generally to audience analysis, and, more particularly, to estimating deduplicated audience of a partitioned audience of media presentations.

### BACKGROUND

Analysis of viewer exposure to media on various media platforms can offer valuable insight for media providers and distributors. As such, gathering accurate and consistent results in addition to data describing viewer exposure is important for these providers and distributors. Graph structures can not only be a useful tool for organizing relationships among entities and aggregating data related to viewer exposure, but can also aid in simplifying computations and estimations related to viewer exposure.

### BRIEF DESCRIPTION OF THE DRAWINGS

FIG. 1 illustrates a schematic diagram of an example system for estimating a deduplicated audience across selected partial unions of graph structures.

FIG. 2 illustrates an example graph structure for estimating a deduplicated audience between partial unions of selected nodes of the example graph structure.

FIG. 3 illustrates nodes of the example graph structure of FIG. 2 for determining a first Qₖ value for a first union of nodes including all connected children nodes.

FIG. 4 illustrates nodes of the example graph structure of FIG. 2 for determining a second Qₖ value for a second union of nodes including all connected children nodes.

FIG. 5 illustrates the example union of FIG. 3 with including the selected nodes for estimating a deduplicated audience within the graph structure across the selected nodes.

FIG. 6 illustrates the example union of FIG. 4 including the selected nodes of FIG. 5 for estimating a deduplicated audience within the graph structure across all of the selected nodes.

FIG. 7 is a flowchart representative of example machine readable instructions and/or example operations that may be executed and/or instantiated by processor circuitry to determine a deduplicated audience.

FIG. 8 is a block diagram of an example processing platform including processor circuitry structured to execute the example machine readable instructions and/or the example operations of FIG. 7 to implement the graph structure decoder of FIG. 1.

FIG. 9 is a block diagram of an example implementation of the processor circuitry of FIG. 8.

FIG. 10 is a block diagram of an example processing platform structured to execute the instructions of FIG. 7 to implement the example graph structure decoder of FIG. 1.

FIG. 11 is a block diagram of an example software distribution platform to distribute software (e.g., software corresponding to the example computer readable instructions of FIG. 7) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Techniques for monitoring user access to an Internet-accessible media, such as digital television (DTV) media, digital advertisement ratings (DAR), and digital content ratings (DCR) media, have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache. Upon execution, the monitoring instructions cause the client to send or transmit monitoring information from the client to a content provider site. The monitoring information is indicative of the manner in which content was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, audio, etc.). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., THE NIELSEN COMPANY, LLC). Since the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

There are many database proprietors operating on the Internet. These database proprietors provide services to large numbers of subscribers. In exchange for the provision of services, the subscribers register with the database proprietors. Examples of such database proprietors include social network sites (e.g., FACEBOOK, TWITTER, MYSPACE, etc.), multi-service sites (e.g., YAHOO!, GOOGLE, AXIOM, CATALINA, etc.), online retailer sites (e.g., AMAZON. COM, BUY.COM, etc.), credit reporting sites (e.g., EXPERIAN), streaming media sites (e.g., YOUTUBE, HULU, etc.), etc. These database proprietors set cookies and/or other device/user identifiers on the client devices of their subscribers to enable the database proprietors to recognize their subscribers when they visit their web sites.

The protocols of the Internet make cookies inaccessible outside of the domain (e.g., Internet domain, domain name, etc.) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so.

The inventions disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. The inventions disclosed in Mazumdar accomplish this task by structuring the AME to respond to impression requests from clients (who may not be a member of an audience measurement panel and, thus, may be unknown to the AME) by redirecting the clients from the AME to a database proprietor, such as a social network site partnered with the AME, using an impression response. Such a redirection initiates a communication session between the client accessing the tagged media and the database proprietor. For example, the impression response received at the client device from the AME may cause the client device to send a second impression request to the database proprietor. In response to the database proprietor receiving this impression request from the client device, the database proprietor (e.g., FACEBOOK) can access any cookie it has set on the client to thereby identify the client based on the internal records of the database proprietor. In the event the client device corresponds to a subscriber of the database proprietor, the database proprietor logs/records a database proprietor demographic impression in association with the user/client device.

As used herein, an impression is defined to be an event in which a home or individual accesses and/or is exposed to media (e.g., an advertisement, content, a group of advertisements and/or a collection of content). In Internet media delivery, a quantity of impressions or impression count is the total number of times media (e.g., content, an advertisement, or advertisement campaign) has been accessed by a web population or audience members (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, a laptop, etc.) and/or a television may be exposed to the same media via multiple devices (e.g., two or more of: a mobile device, a tablet, a laptop, etc.) and/or via multiple media types (e.g., digital media available online, digital TV (DTV) media temporarily available online after broadcast, TV media, etc.). For example, a user may start watching a particular television program on a television as part of TV media, pause the program, and continue to watch the program on a tablet as part of DTV media. In such an example, the exposure to the program may be logged by an AME twice, once for an impression log associated with the television exposure, and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists or non-panelists) for which an audience measurement entity stores demographic information or can obtain demographic information. Deduplication is a process that is necessary to adjust cross-platform media exposure totals by reducing (e.g., eliminating) the double counting of individual audience members that were exposed to media via more than one platform and/or are represented in more than one database of media impressions used to determine the reach of the media.

As used herein, a unique audience is based on audience members distinguishable from one another. That is, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as only a single unique audience member. As used herein, an audience size is a quantity of unique audience members of particular events (e.g., exposed to particular media, etc.). That is, an audience size is a number of deduplicated or unique audience members exposed to a media item of interest of audience metrics analysis. A deduplicated or unique audience member is one that is counted only once as part of an audience size. Thus, regardless of whether a particular person is detected as accessing a media item once or multiple times, that person is only counted once as the audience size for that media item. In this manner, impression performance for particular media is not disproportionately represented when a small subset of one or more audience members is exposed to the same media an excessively large number of times while a larger number of audience members is exposed fewer times or not at all to that same media. Audience size may also be referred to as unique audience or deduplicated audience. By tracking exposures to unique audience members, a unique audience measure may be used to determine a reach measure to identify how many unique audience members are reached by media. In some examples, increasing unique audience and, thus, reach, is useful for advertisers wishing to reach a larger audience base.

Notably, although third-party cookies are useful for third-party measurement entities in many of the above-described techniques to track media accesses and to leverage demographic information from third-party database proprietors, use of third-party cookies may be limited or may cease in some or all online markets. That is, use of third-party cookies enables sharing anonymous subscriber information (without revealing personally identifiable information (PII)) across entities which can be used to identify and deduplicate audience members across database proprietor impression data. However, to reduce or eliminate the possibility of revealing user identities outside database proprietors by such anonymous data sharing across entities, some websites, internet domains, and/or web browsers will stop (or have already stopped) supporting third-party cookies. This will make it more challenging for third-party measurement entities to track media accesses via first-party servers. That is, although first-party cookies will still be supported and useful for media providers to track accesses to media via their own first-party servers, neutral third parties interested in generating neutral, unbiased audience metrics data will not have access to the impression data collected by the first-party servers using first-party cookies. Examples disclosed herein may be implemented with or without the availability of third-party cookies because, as mentioned above, the datasets used in the deduplication process are generated and provided by database proprietors, which may employ first-party cookies to track media impressions from which the datasets are generated.

Disclosed herein are graph structures that can be representative of a connected network of nodes. The graph structures can include one or more nodes connected to other node(s) forming a graph structure with one or more levels of node(s). It is understood that a top node of a graph structure is referred to as a root and node(s) at the bottom-most level of the graph structure are referred to as a leaf or leaves. Node(s) connected to a higher-level node are referred to as children of that node. Similarly, a node located at a next higher level that connects node(s) at a lower level is referred to as a parent node. Furthermore, it is understood that nodes defined as leaves can have a parent but cannot have children or child nodes. Similarly, a node defined to be the root of a graph structure can have children nodes but cannot have a parent node.

The example graph structures disclosed herein include collected data such as a panel data or a census data, which can define a multi-level distribution of media entities. For example, a bottom-most node of the graph structure, or a leaf, can represent an individual entity (e.g., a website, a store, or a television program). A value associated with the leaf can be representative of an audience number that interacts, views, and/or visits that individual entity. Node(s) at higher levels than the leaves, or parent nodes, can be indicative of a deduplicated audience that has interacted with, viewed, and/or visited the one or more nodes connected below, or the leaves that are connected to that parent node. Nodes of the graph structure can be labelled or indexed by a subscript in a consistent manner such as {1, . . . , n} such that indexing begins at leaf nodes and concludes at the root node. A parent of a node k can be labelled as Par(k), for example, which maps node k to a node value of the corresponding parent node. The children of node k are an array of indices expressed by Ch(k) which maps node k to the node values of all of the connected children nodes.

A graph structure can define a network of connections among various media platforms. For example, a network of nodes of a graph structure can indicate one or more business connections in which a company owns individual websites. In some examples, the organization of nodes within a graph structure can change if new entities are added to the structure or removed, for example. As such, a graph structure may need to be transformed by rearranging nodes, adding, or removing nodes. Although more structure within a graph structure can result in a higher correlation between nodes and provide additional information about the panel or census, the transformation of the graph structure can also cause values associated with nodes to become unknown. In other examples, a graph structure can also define database or measurement connections such as measurements of a deduplicated audience across one or more websites that are owned by, or belong to, different companies. In some examples, a deduplicated audience can be estimated for entities that are not directly related, or connected, within a graph structure. For example, a company can own one or more entities and would like to know a deduplicated audience for those entities that it owns without accounting for audience numbers of other companies. As such, the methods disclosed herein can parse out, or exclude, known entities to estimate a deduplicated audience for a set of known or selected entities, or nodes. The entities or nodes selected for the estimation of deduplicated audience members can be connected to a common parent node or can be combined with nodes that are not connected to a common parent node. The invention disclosed herein presents methods and apparatus to estimate a deduplicated audience of selected nodes within a graph structure representative of audiences exposed to media entities. More specifically, the techniques disclosed herein can enable increased consistency in the reporting of audience measurements and aggregated measurement data with improved accuracy than previous or other techniques. The methods disclosed herein can be used independently or with other methods not disclosed herein.

To estimate a deduplicated audience of selected nodes, or entities, a value, is first determined for one or more union of nodes including the nodes selected in that union. In this example, this value is denoted as variable Qₖ where k is a node of an arbitrary intermediate level union with an audience denoted by Aₖ. The value of Aₖ can be a known deduplicated audience. Variable Qₖ is defined as a pseudo-universe estimate parameter that corresponds to that union in which node k is a parent node. The expression for Qₖ defines the solution for the following equation where the product term on the right side is across all children nodes of node k. The known audience for each child node is defined as Aᵢ.

$$1 - \frac{{A}_{k}}{{Q}_{k}} = {Π}_{i ∈ C h ( k )} ( 1 - \frac{{A}_{i}}{{Q}_{k}} ) \qquad ( 1 )$$

Using expression 1, a solution for Qₖ can be determined. The value of Qₖ can then be used to determine an estimate of a deduplicated audience across a selected group of nodes, or a portion of the total nodes connected to the parent node k, rather than all nodes connected to node k. As such, expression 1 can be used to determine more than one value of Qₖ. Specifically, a value of Qₖ for each union of nodes that contains the audience data of all children nodes connected to parent node k that can be used to estimate a deduplicated audience across the selected nodes. In some examples, the solution to Qₖ for each intermediate union can be determined using a fixed-point iteration technique or by other computational methods not disclosed herein. It is to be understood that variables Qₖ, Aₖ, Aᵢ, and k are arbitrary variables and can be denoted with other variables.

With Qₖ value(s) determined for one or more union of nodes including all children nodes connected to a parent node k of that union, the determined Qₖ value(s) can be used with expression 1 to estimate to a deduplicated audience across a group of selected nodes. Beginning at the bottom-most nodes, unions can be constructed with the nodes selected for deduplicated audience estimation. In the example disclosed herein, expression 1 can be modified to replace the Qₖ variable with the corresponding Qₖ value that was determined previously for that union including all children nodes. In this example, the Aᵢ variables remain as the value of the audience at the selected node. As such, the product on the right side of expression 1 can have fewer terms as not all children nodes of the union are selected for estimation of the deduplicated audience. In some examples, the Aₖ variable is replaced with an unknown variable A₁, for example, to denote an estimated deduplicated audience among the selected nodes of the parent node of the observed union. The value of Aₖ, specifically A₁, can then be solved for that particular union. Expression 1 can be modified again to estimate a deduplicated audience for a parent node that defines a union between children nodes that were selected in different unions. In this example, the variable Qₖ is again replaced with the corresponding Qₖ value determined for the union including all children nodes. In some examples, the Aₖ variable is again replaced with an unknown variable A₂, for example, to denote a second estimated deduplicated audience including an additional selected node of the observed union. In this example, the Aᵢ variables remain as the value of the audience at the additional selected node and also include the Aₖ value previously determined, A₁ in this example, as the estimate of the deduplicated audience of the first union of selected nodes. The solution for Aₖ can iteratively change as additional nodes are selected to estimate a deduplicated audience with equation 1 used each time to determine a new value of Aₖ with parameters for Aᵢ, Qₖ changing with each iteration to ultimately determine a final estimate of deduplicated audience across selected nodes of the graph structure.

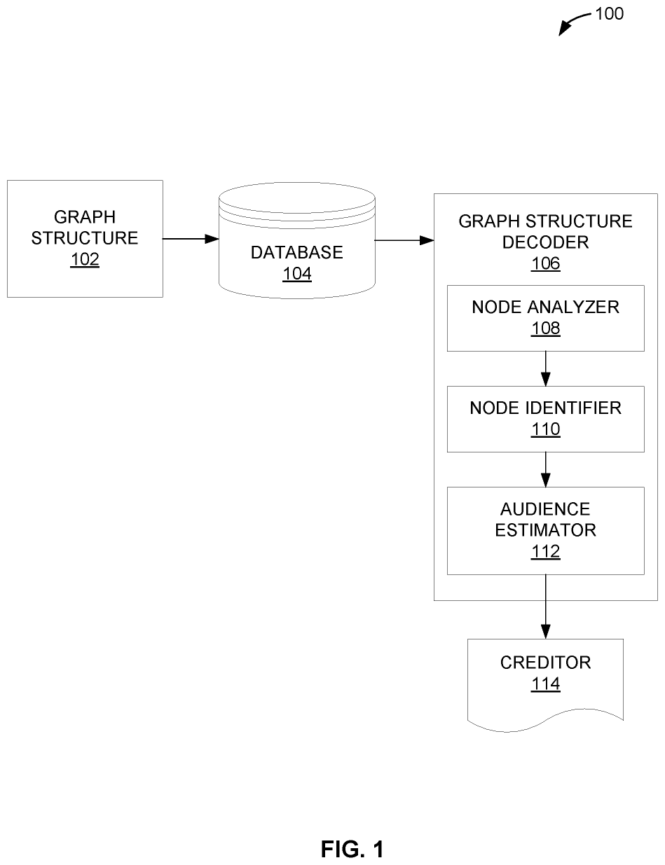

FIG. 1 illustrates a schematic diagram of an example system for estimating a deduplicated audience across selected partial unions of graph structures. The example system 100 includes an example graph structure 102 for analysis. The graph structure 102 is stored in a database 104 with associated metadata (e.g., an audience value) for future retrieval and analysis. Following retrieval from the database 104, the graph structure 102 is passed to a graph structure decoder 106 for analysis. The example graph structure decoder 106 includes a node analyzer 108 to index nodes, identify unions, characterize nodes as children nodes, parent nodes, leaves and/or roots. Once the nodes of the graph structure 102 has been analyzed, a node identifier 110 identifies nodes that are selected for estimation of a deduplicated audience. An audience estimator 112 then uses the selected nodes, remaining nodes, and associated metadata to perform calculations to estimate a deduplicated audience of the partial union of the selected nodes across the graph structure 102. The results of the audience estimator are then reported to the creditor 114.

The example creditor 114 may utilize the deduplicated audience to assign credit to media, to a media provider, to an advertiser, to a network, etc. Additionally or alternatively, the deduplicated audience results may be utilized in any of the ways described in U.S. Pat. No. 10,681,414, entitled “METHODS AND APPARATUS TO ESTIMATE POPULATION REACH FROM DIFFERENT MARGINAL RATING UNIONS,” which is hereby incorporated herein by reference in its entirety.

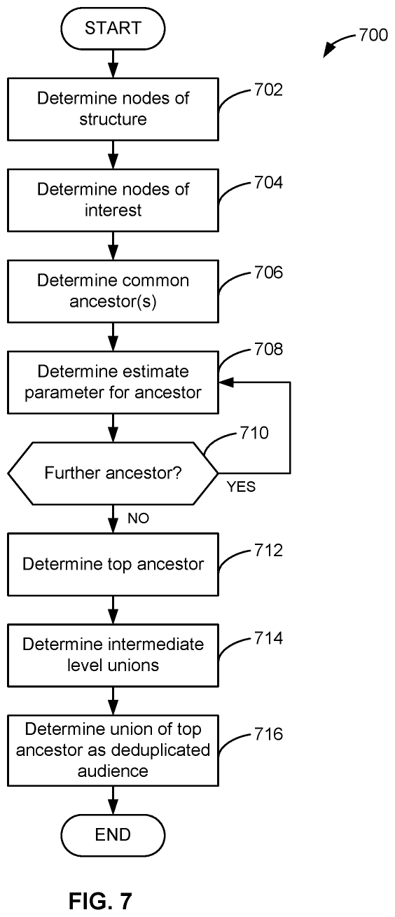

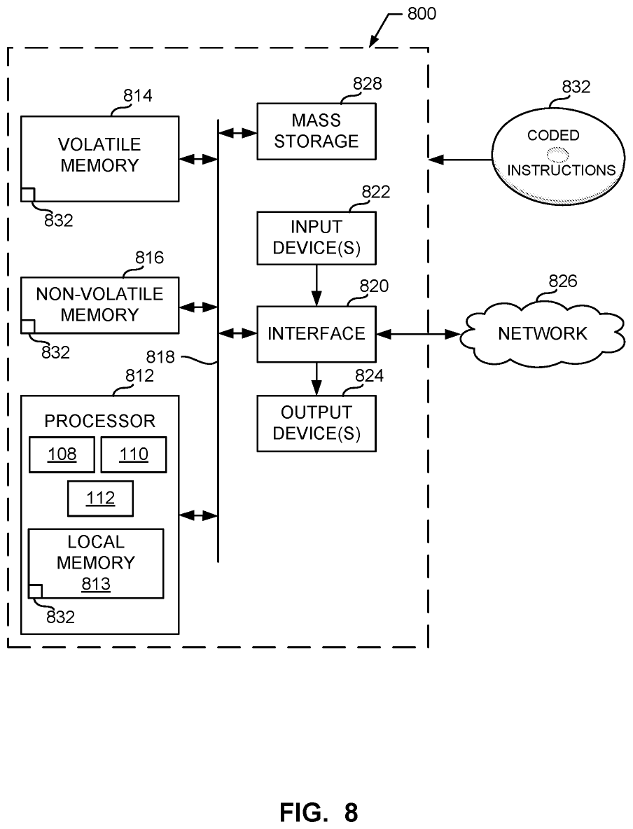

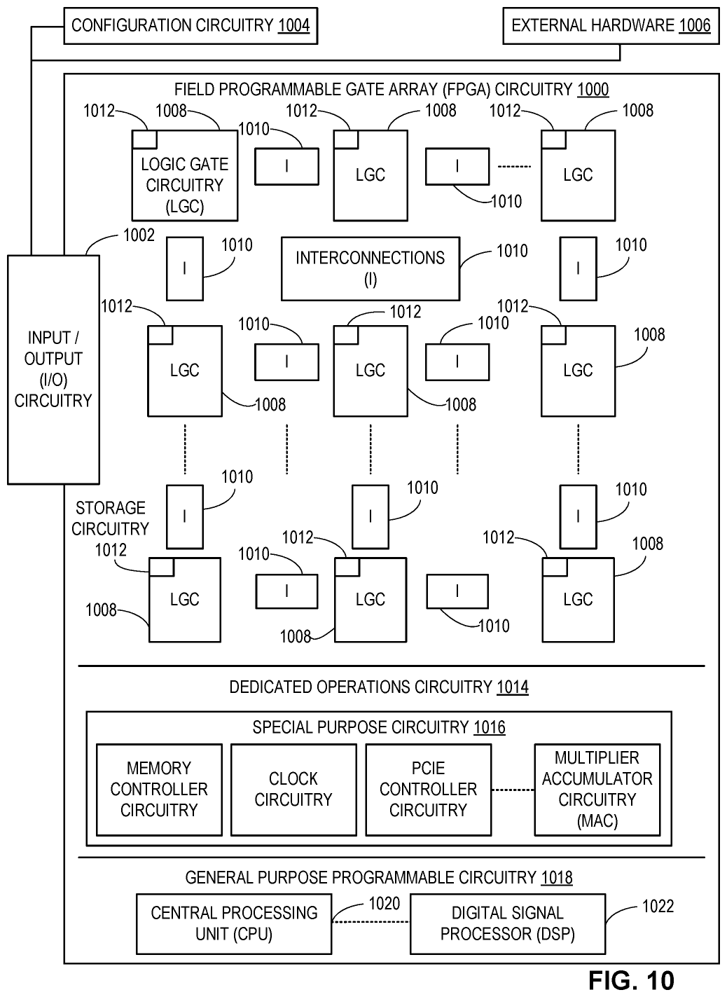

In some examples, the graph structure decoder 106 includes means for analyzing nodes (e.g., nodes in a graph structure). For example, the means for analyzing nodes may be implemented by node analyzer circuitry 108. In some examples, the node analyzer circuitry 108 may be instantiated by processor circuitry such as the example processor circuitry 812 of FIG. 8. For instance, the node analyzer circuitry 108 may be instantiated by the example general purpose processor circuitry 800 of FIG. 8 executing machine executable instructions such as that implemented by at least blocks 702, 706, 710, 712 of FIG. 7. In some examples, the node analyzer circuitry 108 may be instantiated by hardware logic circuitry, which may be implemented by an ASIC or the FPGA circuitry 1000 of FIG. 10 structured to perform operations corresponding to the machine readable instructions. Additionally or alternatively, the node analyzer circuitry 108 may be instantiated by any other combination of hardware, software, and/or firmware. For example, the node analyzer circuitry 108 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the graph structure decoder 106 includes means for identifying nodes (e.g., nodes in a graph structure). For example, the means for identifying nodes may be implemented by node analyzer circuitry 108. In some examples, the node identifier circuitry 110 may be instantiated by processor circuitry such as the example processor circuitry 812 of FIG. 8. For instance, the node identifier circuitry 110 may be instantiated by the example general purpose processor circuitry 800 of FIG. 8 executing machine executable instructions such as that implemented by at least block 704 of FIG. 7. In some examples, the node identifier circuitry 110 may be instantiated by hardware logic circuitry, which may be implemented by an ASIC or the FPGA circuitry 1000 of FIG. 10 structured to perform operations corresponding to the machine readable instructions. Additionally or alternatively, the node identifier circuitry 110 may be instantiated by any other combination of hardware, software, and/or firmware. For example, the node identifier circuitry 110 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the graph structure decoder 106 includes means for estimating an audience. For example, the means for estimating an audience may be implemented by node analyzer circuitry 108. In some examples, the audience estimator circuitry 112 may be instantiated by processor circuitry such as the example processor circuitry 812 of FIG. 8. For instance, the audience estimator circuitry 112 may be instantiated by the example general purpose processor circuitry 800 of FIG. 8 executing machine executable instructions such as that implemented by at least blocks 708, 714, 716 of FIG. 7. In some examples, the audience estimator circuitry 112 may be instantiated by hardware logic circuitry, which may be implemented by an ASIC or the FPGA circuitry 1000 of FIG. 10 structured to perform operations corresponding to the machine readable instructions. Additionally or alternatively, the audience estimator circuitry 112 may be instantiated by any other combination of hardware, software, and/or firmware. For example, the audience estimator circuitry 112 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the graph structure decoder 106 is illustrated in FIG. 1, one or more of the elements, processes and/or devices illustrated in FIG. 1 may be combined, divided, re-arranged, omitted, eliminated and/or implemented in any other way. Further, the example node analyzer 108, the example node identifier 110, the example audience estimator 112 and/or, more generally, the example graph structure decoder 106 of FIG. 1 may be implemented by hardware, software, firmware and/or any combination of hardware, software and/or firmware. Thus, for example, any of the example node analyzer 108, the example node identifier 110, the example audience estimator 112 and/or, more generally, the example graph structure decoder 106 of FIG. 1 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, node analyzer 108, the example node identifier 110, the example audience estimator 112 and/or, more generally, the example graph structure decoder 106 of FIG. 1 is/are hereby expressly defined to include a non-transitory computer readable storage device or storage disk such as a memory, a digital versatile disk (DVD), a compact disk (CD), a Blu-ray disk, etc. including the software and/or firmware. Further still, the example graph structure decoder 106 of FIG. 1 may include one or more elements, processes and/or devices in addition to, or instead of, those illustrated in FIG. 1, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

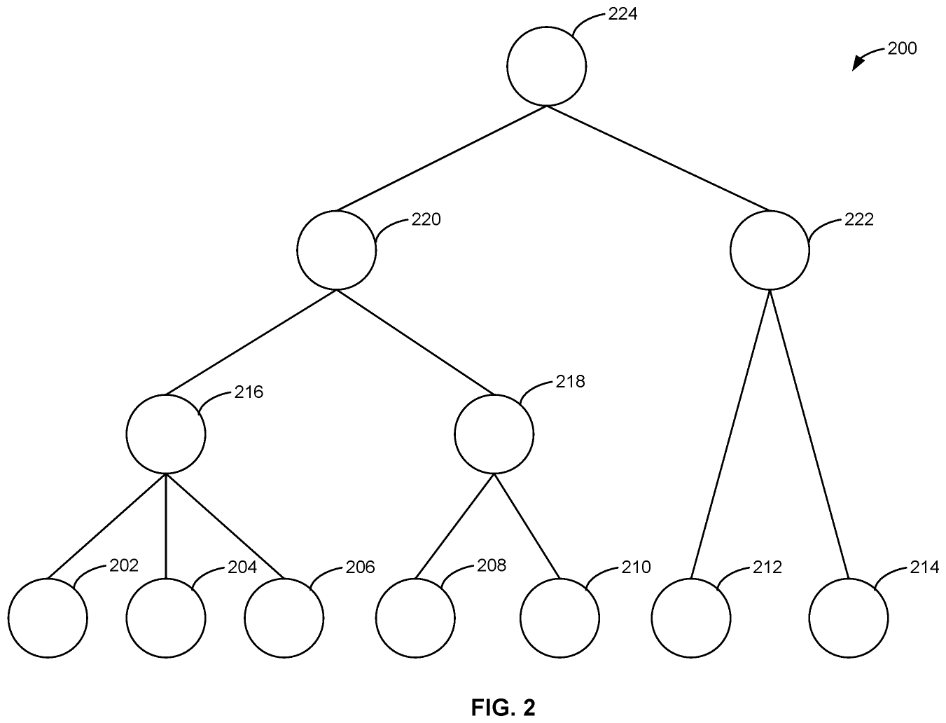

FIG. 2 illustrates an example graph structure for estimating a deduplicated audience among partial unions of selected nodes of the example graph structure. In some examples, each node of the graph structure 200 has a single parent. In the example graph structure 200, the top node 224, or the root, has an example value of 150 denoting the number of unique, or deduplicated, audience members among the lower child nodes 220, and 222. In the example graph structure 200, for purposes of explanation and computation, node 220 has a value of 95 denoting the deduplicated audience between lower children nodes 216 and 218. Example node 222 has a value of 100 denoting the deduplicated audience between lower children nodes 212 and 214. In the example graph structure 200, node 216 has a value of 45 denoting the deduplicated audience between lower children nodes 202, 204, and 206. As such, example node 218 has a value of 70 denoting the deduplicated audience between lower children nodes 208 and 210. Leaf nodes 202, 204, 206, 208, 210, 212, and 214 of the example graph structure 200 has values 10, 20, 30, 40, 50, 60, and 70 respectively denoting audience values of each individual entity. In this example, nodes 202, 204 and 218 of the example graph structure 200 are selected for estimation of a deduplicated audience. In other examples, the graph structure 200 has a different number of total nodes, nodes at each level within the graph structure, a different audience value assigned to each node or has an alternate structure than the structure disclosed herein.

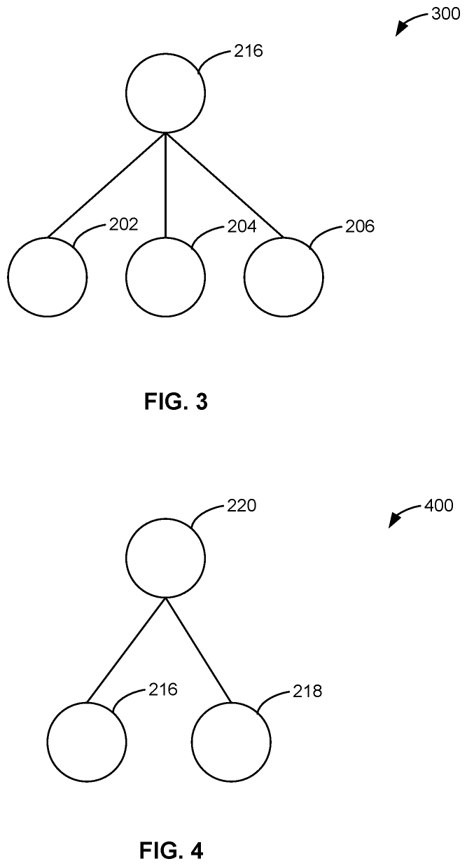

FIG. 3 illustrates nodes of the example graph structure of FIG. 2 for determining a first Qₖ value for a first union of nodes including all connected children nodes. In this example, Qₖ, is denoted as Q₁. For this example, the union 300 includes children nodes 202, 204, and 206 connected to a common parent node 216. As such, the node index for this example union 300 would be Ch(216)={202, 204, 206}. Using expression 1 from above, the value of Q₁ is determined by setting 45 as the value of Aₖ, or the audience of the union at parent node 216. Furthermore, the value of 10, 20 and 30, are used as the values of Aᵢ in each of the three terms of the product on the right side of the expression to denote the audience of individual nodes 202, 204, and 206 respectively. The expression becomes

$$1 - \frac{45}{{Q}_{1}} = ( 1 - \frac{10}{{Q}_{1}} ) ( 1 - \frac{20}{{Q}_{1}} ) ( 1 - \frac{30}{{Q}_{1}} ) \qquad ( 2 )$$

in which solving for Q₁ yields an estimated value of 67.3985. In this example, this determined value of Q₁ is further used in the proceeding calculations to estimate the deduplicated audience across the selected nodes 202, and 204, and 218 as described below.

FIG. 4 illustrates nodes of the example graph structure of FIG. 2 for determining a second Qₖ value for a second union of nodes including connected children nodes. In this example, Qₖ, is be denoted as Q₂. In this example, the union 400 includes children nodes 216, and 218 connected to a common parent node 220. As such, the node index for this example union 400 would be Ch(220)={216, 218}. Using expression 1 from above, the value of Q₂ is determined by setting 95 as the value of Aₖ, or the audience of the union at parent node 218. Furthermore, the value of 45, and 70 are used as the values of Aᵢ in each of the two terms of the product on the right side of the expression to denote the audience of individual nodes 216, and 218 respectively. The expression becomes

$$1 - \frac{95}{{Q}_{2}} = ( 1 - \frac{45}{{Q}_{2}} ) ( 1 - \frac{70}{{Q}_{2}} ) \qquad ( 3 )$$

in which solving for Q₂ yields an estimated value of 157.5. In this example, this determined value of Q₂ is further used in the proceeding calculations to estimate the deduplicated audience across the selected nodes 202, and 204, and 218 as described below. In this example, following the determination of Qₖ values, Q₁ and Q₂, that take into account all children nodes connected to parent node k, 216 and 220, respectively, the Qₖ values are used to estimate the deduplicated audience across the selected nodes of the example graph structure 200.

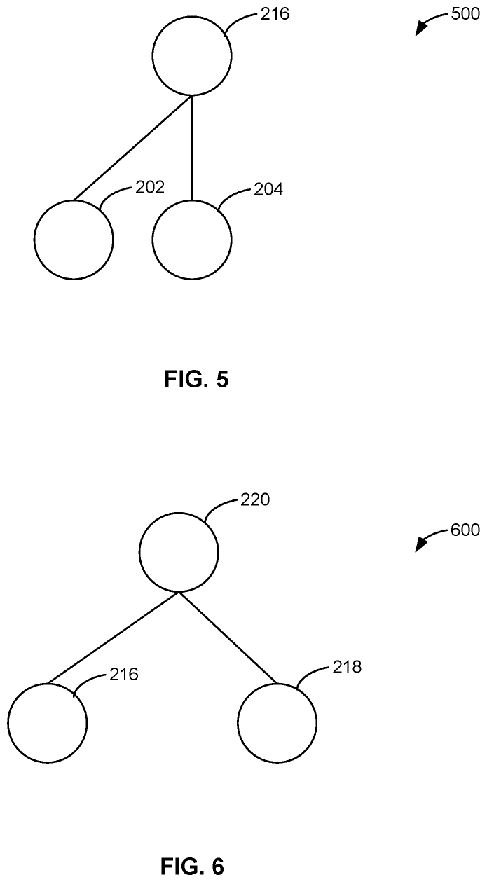

FIG. 5 illustrates the example union of FIG. 3 with including the selected nodes for estimating a deduplicated audience within the graph structure across the selected nodes. As explained above, nodes 202, 204 and 218 are nodes selected for estimation of a deduplicated audience. As such, although nodes 202, 204, and 206 share a common parent, node 216, node 206 is not a selected node for estimation of a deduplicated audience and is therefore not included in the estimation. As such, union 500 does not include node 206. In this example, expression 1 is modified to determine variable A₁, the estimated deduplicated audience of the union 500 at node 216 including selected nodes 202, and 204, where the values of Aᵢ on the right side of the expression are 10 and 20 indicating the audience of the selected nodes 202, and 204 respectively. In this example, the value of Qₖ is the value of Q₁ previously determined accounting all children nodes connected to the common parent node k, node 216, in FIG. 3. The expression, with applied numerical values becomes

$$1 - \frac{{A}_{1}}{{Q}_{1}} = ( 1 - \frac{10}{{Q}_{1}} ) ( 1 - \frac{20}{{Q}_{1}} ) \qquad ( 4 )$$

$$1 - \frac{{A}_{t}}{67.3985} = ( 1 - \frac{10}{67.3985} ) ( 1 - \frac{20}{67.3985} ) \qquad ( 5 )$$

in which solving for A₁ yields an estimated value of 27.0236. This estimated value of A₁ defines an estimated deduplicated audience of 27 people of the union including the selected nodes 202, and 204.

FIG. 6 illustrates the example union of FIG. 4 including the selected nodes of FIG. 5 for estimating a deduplicated audience within the graph structure across all of the selected nodes. As explained in connection with FIG. 5, nodes 202, 204 and 218 are nodes selected for estimation of a deduplicated audience. As the resulting estimation of equation 5 above indicated the estimated deduplicated audience across selected nodes 202, and 204, in this example, the estimated deduplicated audience also includes node 218 in the estimation. In this example, expression 1 is modified to determine variable A₂, the estimated deduplicated audience of the union at node 220 including selected nodes 202, and 204, in addition to 218. In this example, a first value of Aᵢ on the right side of the expression is A₁, the estimated deduplicated audience across selected nodes 202 and 204 determined in equation 5. The second value of Aᵢ on the right side of the expression is 70, the deduplicated audience value for the union at node 218 including children nodes 208 and 210, where node 218 is also selected for analysis in the estimation. In this example, the value of Qₖ is the value of Q₂ previously determined accounting children nodes connected to the common parent node k, node 220, in FIG. 3. The expression, with applied numerical values becomes

$$1 - \frac{{A}_{2}}{{Q}_{2}} = ( 1 - \frac{{A}_{1}}{{Q}_{2}} ) ( 1 - \frac{70}{{Q}_{2}} ) \qquad ( 6 )$$

$$1 - \frac{{A}_{2}}{157.5} = ( 1 - \frac{27.0326}{157.5} ) ( 1 - \frac{70}{157.5} ) \qquad ( 7 )$$

in which solving for A₂ yields an estimated value of 85.0181. This final estimation indicates that the estimated deduplicated audience across the selected nodes 202, 204, and 218 of the graph structure 200 is 85 people. This estimated value of A₂ defines an estimated deduplicated audience of 85 people of the across the selected nodes 202, and 204 in addition to 218. Thus, for this example graph structure 200 the estimated deduplicated audience across the selected nodes is 85 people. This estimated value of 85 people is noted to be smaller than the audience value at node 220 of 95 people which can be explained based on the exclusion of node 206 in the computations.

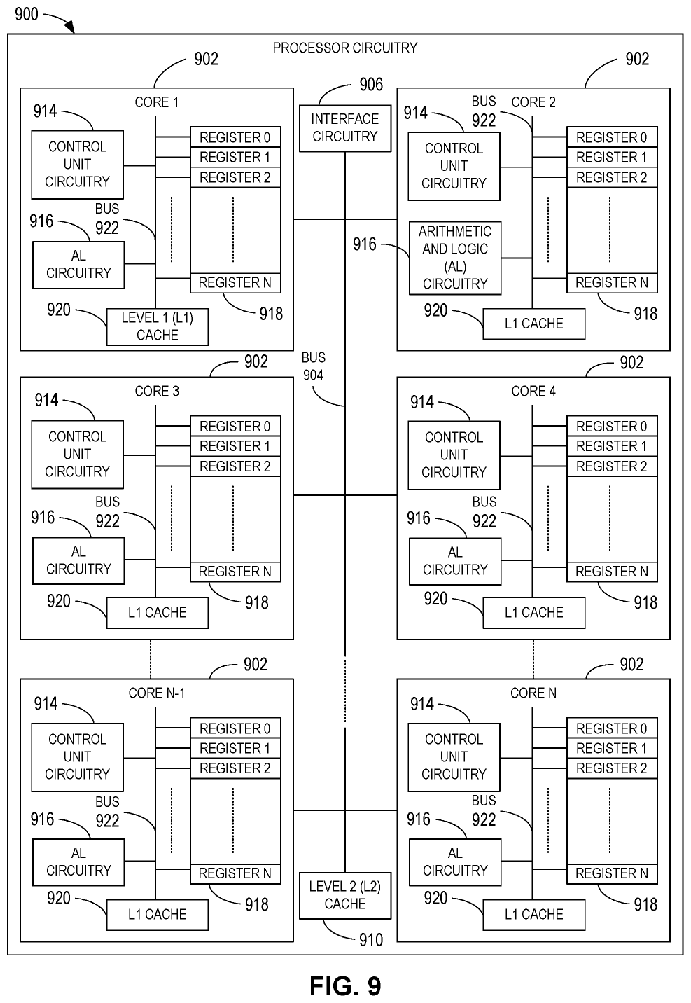

A flowchart representative of example hardware logic circuitry, machine readable instructions, hardware implemented state machines, and/or any combination thereof for implementing the graph structure decoder 106 of FIG. 1 is shown in FIG. 7. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 7, many other methods of implementing the example graph structure decoder 106 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to determine a deduplicated audience. The machine readable instructions and/or the operations 700 of FIG. 7 begin at block 702, at which the node analyzer 108 determines nodes of a structure (block 702). While examples disclosed herein describe nodes in a graph structure, a visual graph structure need not be generated to develop a data structure that associates elements (e.g., nodes) in a structure (e.g., a tree structure) of elements having 0 or more parents and 0 or more children.

The example node identifier 110 then determines nodes of interest (block 704). For example, the node identifier 110 may receive a user input identifying nodes for which a deduplicated audience is requested to be determined. The example node analyzer 108 then determines common ancestors for the identified nodes (block 706). For example, multiple common ancestors may be determined among a plurality of nodes (e.g., two neighboring nodes such as node 202 and node 206 have a common ancestor in node 216 and node 216 and node 218 have a common parent in node 220.

The example audience estimator 112 then determines an estimate parameter for an ancestor (block 708). For example, the audience estimator 112 may determine an estimate parameter (e.g., Aₖ as discussed above) for a first ancestor. The example node analyzer 108 then determines if there are further ancestors (block 710). If there are further ancestors, control returns to block 708 to determine an estimate parameter for the next ancestor.

After there are no further ancestors (block 710), the node analyzer 108 determines a top ancestor (block 712). For example, the top ancestor may be the lowest common ancestor for the identified nodes for analysis. For example, the top node for nodes 202, 204, and 218, is node 220.

The example audience estimator 112 then determines intermediate level unions (block 714). For example, the audience estimator 112 may determine intermediate level unions for each node at a single level (e.g., siblings). For example, if nodes 202, 204, and 218 were the nodes of interest, the intermediate level unions may be determined for nodes 202 and 204 and for nodes 218 and 216. The example audience estimator 112 then determines a union of the top ancestor (block 716). The union of the top ancestor in the illustrated example is a deduplicated audience estimation. For example, the unions may be calculated according to

$$1 - \frac{{A}_{1}}{{Q}_{1}}$$

which is calculated based on the child nodes of interest (e.g., for nodes 202,204

$$( 1 - \frac{A for node 202}{Q for nodes 202 , 204 , 206} ) ( 1 - \frac{A for node 204}{Q for nodes 202 , 204 , 206} ) .$$

Nodes at any other level may be determined according to the same calculation.

FIG. 8 is a block diagram of an example processor platform 800 structured to execute and/or instantiate the machine readable instructions and/or the operations of FIG. 7 to implement the graph structure decoder 106 of FIG. 106. The processor platform 800 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the example node analyzer 108, the example node identifier 110, and the example audience estimator 112.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 832, which may be implemented by the machine readable instructions of FIG. 7, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a general purpose microprocessor 900. The general purpose microprocessor circuitry 900 executes some or all of the machine readable instructions of the flowchart of FIG. 7 to effectively instantiate the circuitry of FIG. 1 as logic circuits to perform the operations corresponding to those machine readable instructions. In some such examples, the circuitry of FIG. 1 is instantiated by the hardware circuits of the microprocessor 900 in combination with the instructions. For example, the microprocessor 900 may implement multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 7.

The cores 902 may communicate by a first example bus 904. In some examples, the first bus 904 may implement a communication bus to effectuate communication associated with one(s) of the cores 902. For example, the first bus 904 may implement at least one of an Inter-Integrated Circuit (I2C) bus, a Serial Peripheral Interface (SPI) bus, a PCI bus, or a PCIe bus. Additionally or alternatively, the first bus 904 may implement any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2_cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the L1 cache 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may implement at least one of an I2C bus, a SPI bus, a PCI bus, or a PCIe bus

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 812 of FIG. 8. In this example, the processor circuitry 812 is implemented by FPGA circuitry 1000. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowchart of FIG. 7 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowchart of FIG. 7. In particular, the FPGA 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowchart of FIG. 7. As such, the FPGA circuitry 1000 may be structured to effectively instantiate some or all of the machine readable instructions of the flowchart of FIG. 7 as dedicated logic circuits to perform the operations corresponding to those software instructions in a dedicated manner analogous to an ASIC. Therefore, the FPGA circuitry 1000 may perform the operations corresponding to the some or all of the machine readable instructions of FIG. 7 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to obtain and/or output data to/from example configuration circuitry 1004 and/or external hardware (e.g., external hardware circuitry) 1006. For example, the configuration circuitry 1004 may implement interface circuitry that may obtain machine readable instructions to configure the FPGA circuitry 1000, or portion(s) thereof. In some such examples, the configuration circuitry 1004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may implement the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and interconnections 1010 are configurable to instantiate one or more operations that may correspond to at least some of the machine readable instructions of FIG. 7 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowchart of FIG. 7 may be executed by one or more of the cores 902 of FIG. 9, a second portion of the machine readable instructions represented by the flowchart of FIG. _ may be executed by the FPGA circuitry 1000 of FIG. 10, and/or a third portion of the machine readable instructions represented by the flowchart of FIG. 7 may be executed by an ASIC. It should be understood that some or all of the circuitry of FIG. 1 may, thus, be instantiated at the same or different times. Some or all of the circuitry may be instantiated, for example, in one or more threads executing concurrently and/or in series. Moreover, in some examples, some or all of the circuitry of FIG. 1 may be implemented within one or more virtual machines and/or containers executing on the microprocessor.

In some examples, the processor circuitry 812 of FIG. 8 may be in one or more packages. For example, the processor circuitry 900 of FIG. 9 and/or the FPGA circuitry 1000 of FIG. 10 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

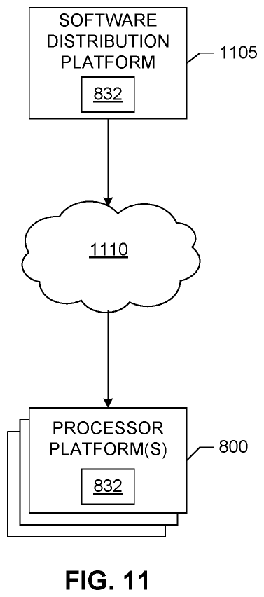

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions 700 of FIG. 7, as described above. The one or more servers of the example software distribution platform 1105 are in communication with a network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions 700 of FIG. 7, may be downloaded to the example processor platform 800, which is to execute the machine readable instructions 832 to implement the graph structure decoder 106. In some example, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

From the foregoing, it will be appreciated that example methods, apparatus and articles of manufacture have been disclosed that estimate a deduplicated audience of a partitioned audience of media presentations. The disclosed methods, apparatus and articles of manufacture improve the efficiency of using a computing device by estimating a deduplicated audience of a partitioned audience of media presentations across selected nodes of a graph structure with improved accuracy and consistency compared to previous techniques using the equations presented herein. The disclosed methods, apparatus and articles of manufacture are accordingly directed to one or more improvement(s) in the functioning of a computer.

Examples presented herein include an apparatus comprising a node identifier to identify one or more nodes of a graph structure selected for estimation of a deduplicated audience and an audience estimator to estimate a value indicative of the deduplicated audience across a first selected node of the graph structure and a second selected node of the graph structure.

An example apparatus to determine a deduplicated audience comprises: interface circuitry to receive an indication of nodes to be analyzed for a deduplicated audience; and processor circuitry including one or more of: at least one of a central processing unit, a graphic processing unit, or a digital signal processor, the at least one of the central processing unit, the graphic processing unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus; a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or Application Specific Integrate Circuitry (ASIC) including logic gate circuitry to perform one or more third operations; the processor circuitry to perform at least one of the first operations, the second operations, or the third operations to instantiate: node analyzer circuitry identify one or more nodes of a graph structure selected for estimation of a deduplicated audience; and audience estimator circuitry to estimate a value indicative of the deduplicated audience across a first selected node of the graph structure and a second selected node of the graph structure.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

In addition, U.S. Pat. No. 10,681,414, entitled “METHODS AND APPARATUS TO ESTIMATE POPULATION REACH FROM DIFFERENT MARGINAL RATING UNIONS” is hereby incorporated herein by reference in its entirety.

What is claimed is:

1. An apparatus to determine a deduplicated audience, the apparatus comprising:
interface circuitry;
instructions in the apparatus; and
processor circuitry to execute the instructions to at least:
identify one or more nodes of a graph structure selected for estimation of a deduplicated audience; and
estimate a value indicative of the deduplicated audience across a first selected node of the graph structure and a second selected node of the graph structure.

2. The apparatus of claim 1, wherein the processor circuitry is to execute the instructions to determine a common ancestor of the selected nodes.

3. The apparatus of claim 1, wherein the processor circuitry is to execute the instructions to determine an estimate parameter for the common ancestor.

4. The apparatus of claim 1, wherein the processor circuitry is to execute the instructions to identify a top ancestor of the nodes.

5. The apparatus of claim 4, wherein the processor circuitry is to execute the instructions to determine an intermediate level union of the nodes.

6. The apparatus of claim 4, wherein the processor circuitry is to execute the instructions to determine the value as the union of the top ancestor.

7. The apparatus of claim 1, wherein the audience is an audience of Internet websites the nodes represent the audience of a plurality of different websites.

8. A non-transitory computer readable medium comprising instructions that, when executed, cause a machine to at least:
identify one or more nodes of a graph structure selected for estimation of a deduplicated audience; and
estimate a value indicative of the deduplicated audience across a first selected node of the graph structure and a second selected node of the graph structure.

9. The non-transitory computer readable medium of claim 8, wherein the instructions, when executed, cause the machine to determine a common ancestor of the selected nodes.

10. The non-transitory computer readable medium of claim 8, wherein the instructions, when executed, cause the machine to determine an estimate parameter for the common ancestor.

11. The non-transitory computer readable medium of claim 8, wherein the instructions, when executed, cause the machine to identify a top ancestor of the nodes.

12. The non-transitory computer readable medium of claim 11, wherein the instructions, when executed, cause the machine to determine an intermediate level union of the nodes.

13. The non-transitory computer readable medium of claim 11, wherein the instructions, when executed, cause the machine to determine the value as the union of the top ancestor.

14. The non-transitory computer readable medium of claim 8, wherein the audience is an audience of Internet websites the nodes represent the audience of a plurality of different websites.

15. A method comprising:
identifying one or more nodes of a graph structure selected for estimation of a deduplicated audience; and
estimating a value indicative of the deduplicated audience across a first selected node of the graph structure and a second selected node of the graph structure.

16. The method of claim 15, further comprising determining a common ancestor of the selected nodes.

17. The method of claim 15, further comprising identifying an estimate parameter for the common ancestor.

18. The method of claim 15, further comprising identifying a top ancestor of the nodes.

19. The method of claim 18, further comprising determining an intermediate level union of the nodes.

20. The method of claim 18, further comprising determining the value as the union of the top ancestor.
